(19) United States
(12) Patent Application Publication
(10) Pub. No.: US 2007/0110151 A1
(43) Pub. Date: May 17, 2007

(54) System and method for video frame buffer compression

(75) Inventors: Siu-Leong Yu, San Jose, CA (US); Nien-Tsu Wang, Los Gatos, CA (US); Kou-Hu Tzou, Sunnyvale, CA (US); Christos Chrysafis, San Jose, CA (US); Xuhui Wu, Sunnyvale, CA (US)

Correspondence Address: ESS TECHNOLOGY, INC;C/O HAYNES BEFFEL & WOLFELD LLP, P.O. BOX 366, HALF MOON BAY, CA, 94019, US

(73) Assignee: ESS Technology, Inc., Fremont, CA (US)

(21) Appl. No.: 11/274,625

(22) Filed: Nov. 14, 2005

(51) Int. Cl. H04N 11/04

(52) U.S. Cl. 375/240.03; 375/240.23

(57) ABSTRACT

A system and method are provided for encoding and compressing video data. A memory device is configured to store video data, and a corresponding memory controller controls the storage of video data in the memory device. A frame buffer compression module compresses frame data received from a video module to be stored in the memory device according to the memory controller and decompresses compressed frame data received from the memory device according to the memory controller for use by a video module. The frame buffer compression module includes a frame buffer compression encoder configured to encode and compress frame data received from a video module for storage in memory according to the memory controller. The frame buffer also includes a corresponding frame buffer compression decoder configured to decode and decompress frame data received from memory according to the memory controller for use by a video module.

### INTRODUCTION

The invention is directed to a novel system and method to compress video data in frame buffers within memory, such as in a Dynamic Random Access Memory (DRAM), or other external memory, which is used in DVD players and other related video products.

When decoding video frames for MPEG standards 1, 2 or 4, or other video coding schemes, some current input frames or previous decoded frames need to be written to or read from storage spaces within external memory. These act as frame buffers for storing input frames and previously decoded frames from different modules for motion compensation or visual display. These frame buffers occupy a great deal of storage space within the external memory and also take up a large amount of bandwidth in the transmission of video data. Thus, to reduce memory cost, it is desirable to adopt frame buffer compression processes. In conventional systems, the motion compensation process requires random access frame data. As a result, conventional video coding schemes, such as MPEG schemes, can not be used. For some schemes using one dimensional or two dimensional transform techniques, the actual component implementations are either expensive or suffer from long processing latencies. In either case, conventional approaches require complicated algorithms.

Therefore, there exists in the art a more effective buffering scheme to overcome the shortcomings of the prior art. As will be seen, the invention accomplishes this in a novel manner.

### DETAILED DESCRIPTION

The invention is directed to a system and method for encoding and compressing video data. The system includes a memory device configured to store video data and a corresponding a memory controller configured to control the storage of video data in the memory device. The system further includes a frame buffer compression module configured to compress frame data received from a video module to be stored in the memory device according to the memory controller and configured to decompress compressed frame data received from the memory device according to the memory controller for use by a video module. In one embodiment, the frame buffer compression module includes a frame buffer compression encoder configured to encode and compress frame data received from a video module for storage in memory according to the memory controller. The frame buffer also includes a corresponding frame buffer compression decoder configured to decode and decompress frame data received from memory according to the memory controller for use by a video module.

1. The Invention

The invention is directed to a novel buffer compression system, where two embodiments are described below. It will be understood by those skilled in the art, however, that the spirit and scope of the invention is not limited to the implementations described herein, but are defined in the appended claims and their equivalents and future claims in subsequent applications and their equivalents.

In a preferred embodiment, frame data is compressed in segments, and the frame buffer encoder further includes a quantizer configured to quantize an input frame segment to generate a quantized output; a DPCM configured to modulate the quantized output to generate a modulated output; a rice mapping module configured to perform rice mapping on the modulated output to generate a mapped output; and a variable length coding module (VLC) configured to encode the mapped output. The invention may further include a bit budget module configured to test whether a compressed segment is within a predetermined limit and feedback loop configured to select mode parameters for the quantizer and the VLC. The invention may further include a packing module configured to prepare package including a compressed data segment if the segment is compressed within the predetermined limit and feedback loop configured to select mode parameters for the quantizer and the VLC if the segment is not compressed within the predetermined limit. The invention may further include a worst case mode module configured to compress the segment if it is not within the predetermined limit wherein the packing unit is configured to prepare and generate a package having the worst case compressed segment and mode information.

The frame buffer encoder further includes a smoothing module configured to perform a smoothing operation on an input pixel segment; a modified rice mapping component within the rice module configured to perform modified rice mapping on the modulated output to generate a mapped output; a bit borrowing module configured to share bit space among compressed segments to be transmitted; and a toggle module configured to perform a toggle operation to change a portion of the input pixel segments by toggling the bits that represent the segments. The toggle module may be configured to toggle the bits of every other frame for the same location.

On the decoder side of the system, the frame data along with mode information that identifies the mode in which the segments are compressed and encoded is decoded and decompressed in segments. The decoder may include an inverse variable length decoding module configured to decode the mapped output; an inverse rice mapping module configured to perform inverse rice mapping on the inverse modulated output to generate a mapped output; an inverse DPCM configured to inverse modulate the inverse quantized output to generate a inverse modulated output; and an inverse quantizer configured to inverse quantize an input frame segment to generate an inverse quantized output. The unpacking module is configured to unpack a received packet packet including the compressed data segment and mode information, and a feed-forward loop configured to send mode parameters for the quantizer and the VLC. The frame buffer decoder may further include an inverse bit borrowing module configured to share bit space among compressed segments to be transmitted; an inverse modified rice mapping component within the rice module configured to perform modified rice mapping on the modulated output to generate a mapped output; and an inverse smoothing module configured to perform a smoothing operation on an input pixel segment.

In one embodiment, the unpacking module may be configured to unpack a received packet including the compressed data segment and mode information, and a feed-forward loop configured to send the compression mode parameters for the quantizer and the VLC. In another embodiment, it is configured to unpack and feed forward mode information for the smoothing module, quantizer and the VLC. In either case it is configured to unpack worst case mode parameters configured to decode any received compressed data that was packed according to a worst case mode.

The bit borrowing module may be configured to maintain a pool of available bit space from previously compressed segments for use to store bits that represent subsequent segments, and possibly up to the limit of the bit space required for the previous segment for use to store bits that represent subsequent segments.

The rice module may be configured to perform a modified rice mapping on the modulated output to generate a mapped output that represents the values of a segment that is skewed from a rice mapping center point. A segment may be initially mapped using rice normal rice mapping beginning with a center point until an end of the segment is reached and then maps the remainder of the segment in a consecutive manner to generate a mapped output that represents the values of a segment that is skewed from a rice mapping center point.

The smoothing module may be configured to perform a smoothing operation on an input pixel segment by averaging the values of a plurality of segments prior to compressing and decoding the plurality of segments. The smoothing process may include transmitting information that a plurality of segments were compressed and encoded according smoothing mode to a decoder so that the segment can be accurately decoded. The smoothing process includes transmitting information that a plurality of segments were compressed and encoded according smoothing mode to a decoder so that the segment can be accurately decoded.

The toggle module may be configured to perform a toggle operation to change a portion of the input pixel segments by toggling the bits that represent the segments. The toggle module may be configured toggle the bits of every other frame for the same location.

In operation, the system configured according to the invention may begin with first receiving write request and video frame data from a video module to store video data into memory. In response, the system compresses and encodes a frame segment of the data received from the video module and stores the compressed and encoded segment in a memory device according to a memory controller. On the decoder side, the system can receive receive a read request from a video module, then decompress and decode segments of frame data received from the memory device according to the read request from the video module, then send the decompressed segments of frame data to the module. Compressing the segments may include encoding and compressing segments of frame data received from a video module with a frame buffer compression encoder for storage in memory according to a frame memory controller. Decompressing may include decoding and decompressing segments of frame data received from memory with a frame buffer compression encoder according to a frame memory controller.

In one embodiment, the system may perform the method of encoding by quantizing an input frame segment to generate a quantized output; performing differential pulse code modulation (DPCM) of the quantized output to generate a modulated output; performing rice mapping on the modulated output to generate a mapped output; and performing variable length coding module (VLC) configured to encode the mapped output. Before sending a packaged segment, the system may first test for a predetermined bit limit by testing with a bit budget module whether a compressed segment is within a predetermined limit; and selecting mode parameters with a feedback loop for the quantizer and the VLC. If the segment is not within the bit limit, it may change the mode of one or more components within the encoding process, selecting mode parameters for the quantizer and the VLC if the segment is not compressed within the predetermined limit. If it is not within the predetermined limit, and if other modes are not able to bring the bit count below the bit limit, the segment may be compressed in a worst case mode, and a packaging unit may prepare and generate a package having the worst case compressed segment and mode information for use by the decoder.

In another embodiment, the encoder configured according to the invention may further enhance the system by performing a smoothing operation on an input pixel segment; performing modified rice mapping on the modulated output to generate a mapped output; and sharing bit space among compressed segments to be transmitted. In such a system, the packing module may then be configured to generate a packet including the compressed data segment and mode information if the segment is within the predetermined limit, where the mode parameters for the smoothing module, quantizer and the VLC are included. If not within the predetermined limit, the same package may be configured with the segment compressed under the worst case mode and include worst case parameters for decoding.

Upon receiving the packaged segment by the decoder, the system may be configured to process the segment by decoding the mapped output with an inverse variable length decoding method; performing an inverse rice mapping on the inverse modulated output to generate a mapped output; performing an inverse DPCM modulation on the inverse quantized output to generate a inverse modulated output; and performing an inverse quantization of an input frame segment to generate an inverse quantized output. The decoder may include an unpacking module configured to unpack a received packet including the compressed data segment and mode information, and sending mode parameters for the quantizer, the VLC, the smoothing module if one exists in a feed forward loop. The unpacking module may also include a worst case decoder module for decoding a segment encoded in the worst case mode if it is encoded in such a mode. At the decoder, the packet including the compressed data segment and mode information is unpacked, and the compression mode parameters for the smoothing module, quantizer and the VLC are fed forward for the decoding process. The unpacking module may further include unpacking worst case mode parameters configured to decode any received compressed data that was packed according to a worst case mode.

Among the different segments packaged, the packaged segments may share bit space among compressed segments to be transmitted. The sharing of the bit space includes maintaining pool of available bit space from previously compressed segments for use to store bits that represent subsequent segments. The sharing of the bit space further includes maintaining a pool of available bit space from previously compressed segments up to the bit space required for the previous segment for use to store bits that represent subsequent segments.

The rice mapping may further include performing a modified rice mapping on the modulated output to generate a mapped output that represents the values of a segment that is skewed from a rice mapping center point. This may be performed until an end of the segment is reached and then maps the remainder of the segment in a consecutive manner to generate a mapped output that represents the values of a segment that is skewed from a rice mapping center point. The method may be performed on pixel segments by averaging the values of a plurality of segments prior to compressing and decoding the plurality of segments.

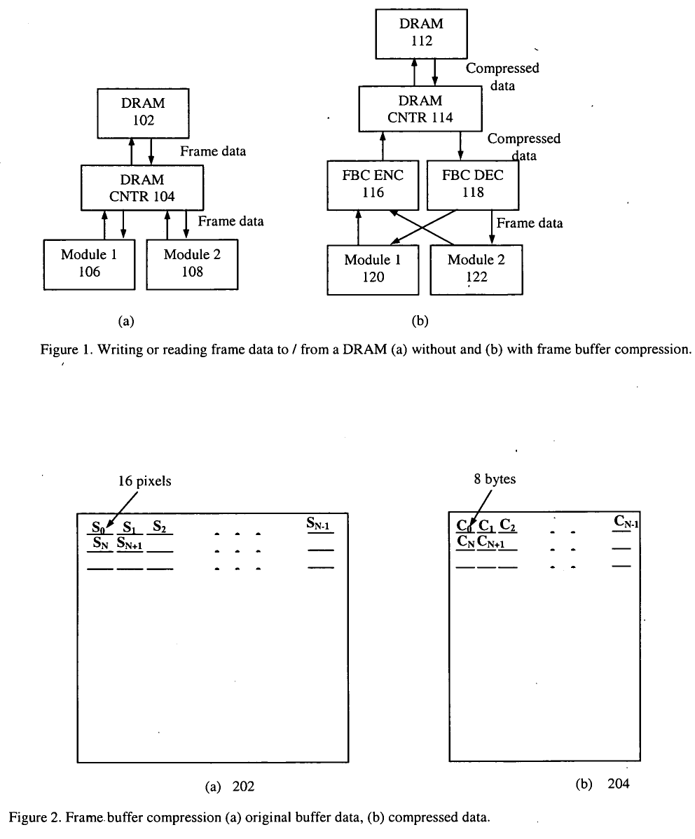

FIG. 1(a) is a diagrammatic view of a conventional system 100 configured for writing to or reading from memory, a DRAM 102 in this illustration, for frame data. The memory controller, a DRAM controller 104 in this illustration, handles multiple read or write requests from the modules, 106, 108. It schedules these requests in a queue using a proper scheme with priority methods and processes one request at a time. It calculates some physical addresses for memory locations in DRAM from the request to store or retrieve the frame data, then it receives or delivers the frame data to the respective module.

FIG. 1(b) is a diagrammatic view of a system 110 configured according to the invention that provides frame buffer compression. The system includes memory, a DRAM 112 in this illustration, that receives requests for read and write operations from a memory controller, a DRAM controller 114 in this illustration. The system further includes frame buffer compressors (FBCs) 116 and 118, configured to provide compression and decompression functions when processing read and write requests from modules 120, 122. The FBCs may be integrated into a single module, but they perform separate functions with respect to effecting read and write operations in the memory 112 according to the memory controller 114. The FBC encoder 116 is configured to receive and encode frame data from modules 120, 122, when write requests are received, compress the frame data, then transmit the compressed and encoded frame data to the memory 112 via memory controller 114. When requests are received from modules for frame data to be read from memory, FBC decoder 118 is configured to read the compressed and encoded frame data from memory 112 via memory controller 114, to decompress and decode the frame data for use by the modules.

Still referring to FIG. 1(b), in operation, when writing frame data to memory, a DRAM in this illustration, the data is compressed and written to a smaller memory space by the frame buffer compression (FBC) encoder. When retrieving the frame data, this compressed data is read out from DRAM and decompressed with an inverse process by the FBC decoder. The decompressed data is then passed to the module that requests the frame data. According to the invention, the new address for writing and reading the compressed data is calculated automatically by the FBC encoder and decoder and the requests to DRAM controller are modified accordingly. Thus, from the point of view of the module, there is no change in the operations for the requests. For simplicity and example, data other than frame data is not shown in FIG. 1 or other diagrams. The description below illustrates the processing the luminance component of video data. However, the invention is not so limited, and is intended to apply to other components of video data, such as chrominance. Furthermore, those skilled in the art will understand that systems can be configured to process other video components without departing from the spirit and scope of the invention, such as to chrominance components in a similar manner.

In a more detailed embodiment, a system may be configured for a 2:1 compression ratio with segments of 16-pixel data, where each pixel is one byte. This embodiment is intended as an example of a specific embodiment of the invention, and is not intended as limiting to the invention in any way. FIG. 2(a) shows multiple segments in memory location 202 with a size of M×N pixels and segments {Sₖ, k ε I}, scanning in a raster order, where I={0, 1, . . . , M×N/16−1}. The FBC encoder compresses these segments into compressed data {Cₖ, k ε I} in memory location 204, each with 8 bytes in this example.

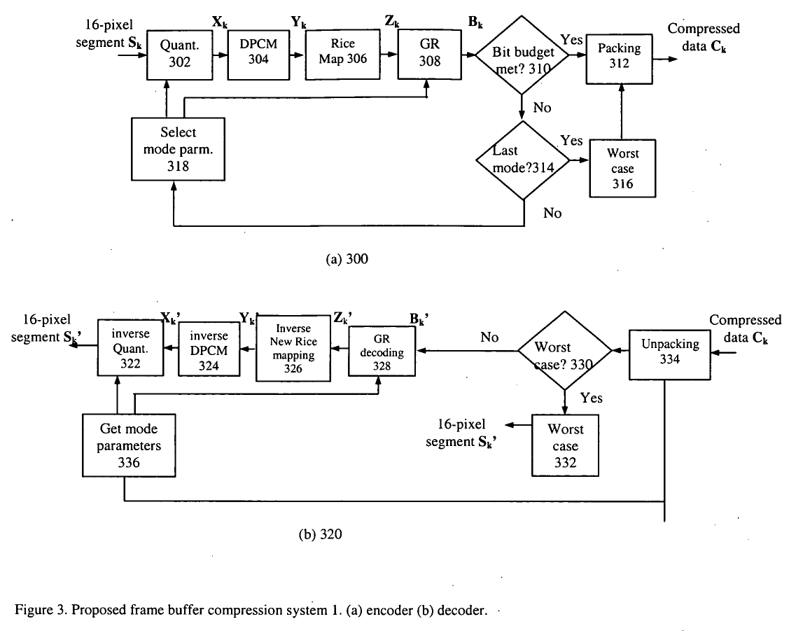

FIGS. 3(a) and 3(b) illustrates a block diagram of a system according to the invention that includes a FBC system in an encoder, 300 and decoder 320. The encoder 300 is configured to receive a video frame input, in this example a 16-pixel frame segment, into a quantizer 302.

Assuming an input segment is 16-pixel data be Sₖ={sᵢ, i ε I₁}, where I₁={0, 1, . . . , 15} and output compressed data be Cₖ, each pixel sᵢ is an 8 bit data segment. For a 2:1 compression ratio, the bit budget is 16×8/2=64 bits for the number of bits of Cₖ. In the embodiment illustrated in FIG. 3(a), the encoder performs processes of quantization, DPCM, Rice Mapping and Golomb-Rice (GR) coding to Sₖ with some selecting parameters for quantization and GR coding. Let Xₖ, Yₖ, Zₖ and Bₖ be the corresponding outputs.

If the number of coding bits is not greater than the bit budget, the coding bits of each sᵢ are packed properly and stored to DRAM. Otherwise, another mode is used with other parameters to encode the Sₖ. If even last mode fails to meet the bit budget, a worst-case mode is used to encode the Sₖ to meet the bit budget constraint. When decoding compressed data Cₖ, as in FIG. 3b, the decoder performs reverse processes to reconstruct the corresponding values Xₖ′, Yₖ′, Zₖ′ and Sₖ′. Below, the detail of each process is described.

Still referring to FIG. 3(a), the segment is quantized according to the invention, and the output Xₖ is sent to Differential Pulse Code Modulator 304. The modulated output Yₖ is transmitted to the Rice mapping module 306 where Rice mapping is performed. The output Zₖ is transmitted to GR Coding module 308 for GR coding. The separate functions of these module are discussed in more detail below. The output Bₖ is transmitted to decision module 310 to determine whether the bit budget has been met. As also described in more detail below, the purpose of the compression operations of the invention is to produce video segments within a predetermined number of bits, a bit threshold. Once it is met, then the packing unit 312 packs the data and outputs compressed data segment Cₖ. If, however, the budget is not met, then the process diverts to step 314, where it is determined if the process has processed the frame data in the last of a plurality of modes, or whether each has been performed. According to the invention, the encoding process can operate in a variety of modes in order to best compress the segment data so that the output is within the bit budget. Specifically, the quantization and GR coding can be performed in a variety of modes to produce different outcomes, ultimately in an attempt to produce a compressed video segment within the predetermined bit budget that is tested for in step 310. If all modes have been performed, and the bit budget has not been met, then the worst case mode is performed in step 316, a fallback position, where the an alternative compression is performed, and the output is sent to the packing module 312 to produced the compressed data. If, however, the process has not been performed in all modes, then the process proceeds to step 318, where new mode parameters are selected, and the process is repeated in another attempt to compress the data. Again, if the bit budget is met, the process proceeds to packing 312, and a compressed output Cₖ results, including the compressed data segment and related mode data. If the bit budget is not met, and once the operation has been performed in the final mode available, then the worst case mode is performed, and the compressed data segment is output from the packing module 312.

Referring to FIG. 3(b), a diagrammatic view of the corresponding decoder system 320 is illustrated. The compressed segment data Cₖ− is received in unpacking module 334, where the mode parameters are unpacked and sent to the mode parameters module 336. In step 330, it is determined whether the encoder 300 compressed the video segment under the worst case mode in module 316. If the answer is yes, then the decoder decodes the compressed data under the worst code decoding mode to output a decoded segment, here a 16-pixel segment Sₖ. If it was not processed in the worst case mode, then the process proceeds to step 328, where the GR decoding is performed. Before this process begins, however, the code parameters will have been distributed to the inverse quantization module 322 and the GR decoding module 328. Thus, the process can perform the inverse rice mapping operation in module 326, followed by the inverse DPCM in module 324 and finally the inverse quantization in step 322 in the mode in which it was compressed in the encoder/compressor system 300 to output a segment, in this case a 16-pixel segment Sₖ.

According to the invention, a method of quantization is provided to quantize a video data segment. Accordingly, the dynamic range can be adjusted at the quantization level, and the quantizes value can be represented in a smaller number of bits. To reduce the number of bits to encode the pixel data sᵢ of Sₖ, it can be quantized with a quantization step Qₛ defined as follows.
xᵢ=int(sᵢ/Qₛ) (1)
where Xₖ={xᵢ, i ε I₁} is the quantization output and the function int (x) represents establishing an integer representation of x with a proper rounding. Since the dynamic range of data becomes smaller, a smaller number of bits can be used to represent the quantized value. Reducing the dynamic range has a consequence of a potential increase in quantization error, but the benefit is a reduced bit rate output for the quantizer, reducing the bandwidth required for transmission and further improving the compressibility of the data. For example, if the quantization step Qₛ=4, the value of xᵢ becomes a 6-bit data representation with a dynamic range of 64.

In the decoding process, the reconstructed pixel value Sₖ′={sᵢ′, i ε I₁} can be calculated by an inverse quantization process as
sᵢ′=xᵢ×Qₛ (2)

It is important to note that there is no loss if Qₛ=1. To simplify the implementation, the values of powers of 2 can be used for Qₛ so that the division and multiplication in equations (1) and (2) above can be easily calculated by a bit shifting.

According to the invention, it has been observed that there is a correlation between neighborhood pixel values. Therefore, the dynamic range of most values can be further reduced by using a Differential Pulse Code Modulation (DPCM) coding that considers the difference between a current pixel value and a prior pixel value. For example according to one embodiment, the formula for values of y can be as follows:
yᵢ=xᵢ−xᵢ₋₁ for i ε I₁−{0} and y₀=x₀, (3)

where Yₖ={yᵢ, i ε I₁}. The reconstructed value Xₖ′={xᵢ′, i ε I₁} can be calculated by a DPCM decoding as
xᵢ′=yᵢ+x′ᵢ₋₁ for i ε I₁−{0} and x₀′=y₀. (4)
Note that there is no loss for this process.

For the dynamic range, assume that xᵢ ε [0, L−1]. Using Eq. (3), it can be shown that the range of DPCM output yᵢ ε [−(L−1), L−1]. This means that the dynamic range becomes almost double. However, it has been observed that most values of yᵢ concentrate in a region around the value of zero. For a typical data set, the distribution of yᵢ follows a Laplacian distribution. This property leads the use of variable length coding, discussed below, to code yᵢ effectively.

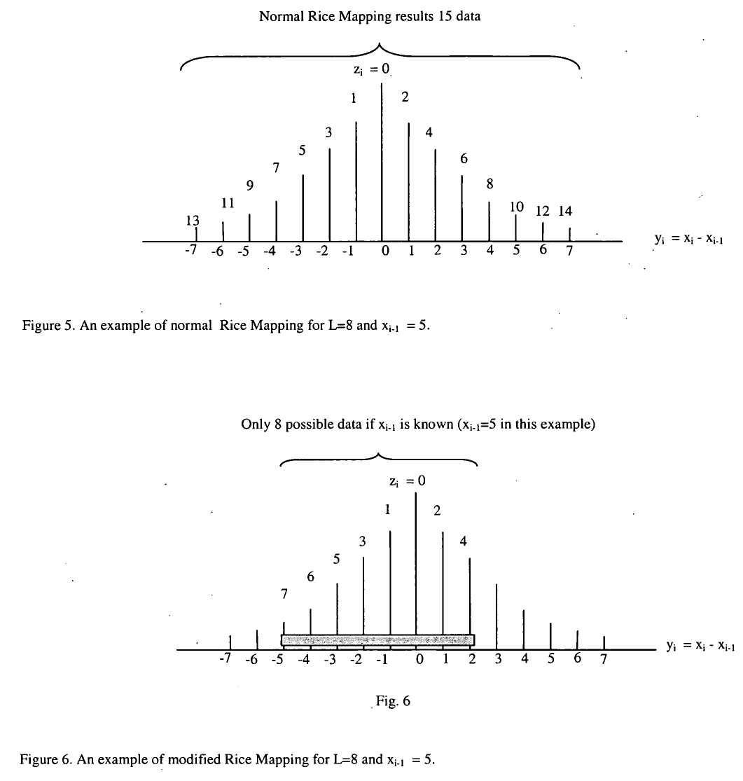

For the output value of DPCM, when encoding yᵢ, the value can be positive or negative. It has been observed that the majority of the data values exist around the zero point. According to the invention, instead of encoding its magnitude and sign separately, Rice mapping is used for improving the coding performance. This is because the resulting values concentrate in a region around the zero value. Referring to FIG. 5, a Laplacian distribution of rice mapping is illustrated, where values are chosen alternately, as indicated by the order beginning with zᵢ=0, then 1 (yᵢ=−1), then 2 (yᵢ=1), then 3 (yᵢ=−2) and so on up to zᵢ=14, where the L=8, in this illustration. The Rice mapping process encodes the value of yᵢ into:
Zₖ={zᵢ, i ε I₂}, where I₂={0, 1, . . . 2(L−1)} as
Where
zᵢ=2|yᵢ| for yᵢ≧0; and
zᵢ=2|yᵢ|−1 for all other values. (5)
The reconstructed value of yᵢ can be calculated by an inverse Rice mapping as
yᵢ′=zᵢ/2 for zᵢ is an even number
yᵢ′=−(zᵢ+1)/2 for all other values. (6)

Since the values of DPCM with the Rice mapping concentrate in a small value region, variable length coding (VLC) can be used to compress the data effectively. To tradeoff the coding efficiency and implementation cost, the GR coding is adopted for VLC coding for its simplicity and its requiring of no code tables. Let “m” be the GR coding parameter which is powers of 2 as, m=2^{k}. The GR coding of zᵢ consists of an unary part and binary part. The unary part is formed as consecutive D zeros with a comma bit ‘1’, where D is the quotient of zᵢ dividing by m. The binary part is just the last k bits of zᵢ in a binary representation. For example, if zᵢ=22 and m=4, it implies that k=2 and D=5. Then, the unary part is ‘000001’ with five consecutive zeros, indicating D=5. Since the binary representation of zᵢ, 22=‘10110’, the binary part becomes ‘10’, where the last 2 bits of zᵢ are used as the binary part of the number representation. Combining the unary and binary parts, the GR coding of zᵢ for this example is ‘00000110’.

To decode the GR coding, the quotient of zᵢ can be recovered by dividing by m. This is done by counting the number of zeros until hitting the comma bit ‘1’. Next, k bits are extracted from the comma bit as the binary part. The final decoding value is formed by multiplying the quotient with m and adding the result with the binary part.

To simplify the implementation for decoding, the invention provides a process for avoiding using a long unary during encoding. This is done by setting a threshold level at which the encoding process will exit the FBC system and select another mode for encoding. This value can be preset as a default limit where the FBC process is stopped. Thus, if the length of any unary in the above discussion is above some user-defined threshold value, such as 15 for example, the GR coding exits and the FBC system selects other mode. So, for example, a larger number to be encoded, such as 35, would have a larger number of bits for representation. If 15 is set for the default threshold for the failure of the FBC system, then 35 would be past the threshold level.

Two or more parameters may be selected for different modes in an implementation, and there is always a tradeoff between the coding distortion and efficiency. The modes exist are the quantization step Qₛ and the GR coding parameter m. There are many combinations for these selections. Theoretically, the more modes a system has, the better it can find a proper mode to encode the input 16-pixel values. However, there is a limit to the number of modes to be utilized in a system. This is because the compressed data is transmitted to a decoder system along with the mode information regarding the types and number of modes used to encode and compress the data. For example, in one embodiment used in practice, three bits at most are used for the mode information, therefore, at most eight modes may be used. Those skilled in the are will understand that there are such tradeoffs in different implementations, and the invention is directed to any such combinations and permutations of modes used for the encoding and compression process. In operation, the modes in which segments are compressed and encoded are identified, and information related to these modes are sent along with the compressed and encoded segments to the decoding and decompression process so that the segments are decoded and decompressed accurately.

For some cases, even all modes are tried, the number of output bits fails to meet the bit budget. In this case, a worst case mode is used. The input pixel values are quantized with minimum Qₛ values such that the number of total bits satisfies the bit budget constraint. Since the bits for indicating the mode selection should be included for the calculation, some pixel values are quantized more to cover the mode selection bits. To spread out the quantization error, these pixels are selected as evenly distributing among the input pixels. For example, for the 2:1 compression with 3-bit mode selection, pixel 3, 7 and 11 are quantized by 32 to become 3-bit data and the remaining pixel values are quantized by 16 to become 4-bit data. The total number bits is (3×3+13×4+3)=64 which equals to the bit budget.

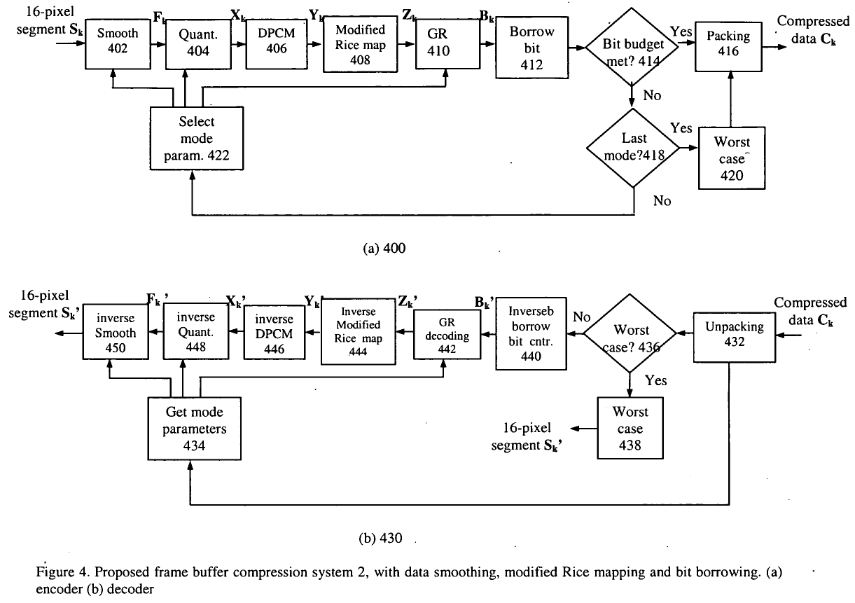

To further improve the coding performance, the invention provides another embodiment, an enhanced system for performing frame buffer compression, and one implementation is depictured in FIGS. 4(a) and 4(b) with the FBC coding and decoding. There are four significant changes compared to the embodiment discussed above. Two modules of smoothing and borrow bit control are added, a novel Rice mapping operation is used and a scheme to toggle input segment value is proposed. The detail of these changes are discussed below. First, referring to FIG. 4(a), an embodiment of the alternative and enhanced system configured according to the invention is illustrated. Decoder 400 receives an input signal, in this example a 16-pixel segment Sₖ into smoothing module 402, which outputs a smoothed-out segment Fₖ. This output is quantized in quantizer module 404, which outputs Xₖ to DPCM 406. DPCM 406 outputs Yₖ into modified Rice mapping module 408, which outputs a Rice mapped output Zₖ to GR coding module 410. The GR coding module outputs Bₖ to the query module 414 that determines whether the bit budget has been met, similar that described above: If it is met, then packing module 416 packs and outputs compressed data segment along with the corresponding mode data in package Cₖ for use by a decoder. If the bit budget is not met, however, the process goes from step 414 to step 418, where it is determined whether the final of possibly several modes have been performed. If the answer is yes then the worst case mode is set in step 420, and the segment is compressed according to this mode, packed in step 416 and output as compressed output Cₖ. According to the invention, one or more modes of compression and encoding operations can be implement, and the select mode parameters module 422 determines which modes the smoothing module 402, the quantization module 404 and the GR coding module 410 operates. These separate modules and the modes in which they operate are described in more detail below. This feedback system continues until either the big budget is met or the process has encoded and compressed the segment in each mode, and a compressed output Cₖ results.

Next, referring to FIG. 4(b), the corresponding decoder 430 is illustrated. The system 430 receives the compressed data input Cₖ an unpacks it in unpacking unit 432. The mode parameters are sent to mode parameter module 434 to establish the mode in which the unpacked compressed segment was encoded. It is then determined whether the worst case mode was implemented in step 436. If it was, then the segment is decoded in the worst case mode module 438, and an output segment Sₖ′, in this illustration a 16-pixel segment, is produced. If the segment was encoded according to another mode, then the process proceeds to step 440, where inverse bit borrowing is performed, giving output Bₖ′. This output is sent to the GR decoding module 442 for GR decoding, producing Zₖ′ which is sent to the inverse modified rice mapping module 444, yielding output Yₖ′. Inverse DPCM module 446 performs the inverse DPCM process on Yₖ′, giving Xₖ′. Inverse quantization module 448 performs the inverse quantization process to yield Fₖ′ and the inverse smoothing module performs the inverse smoothing to produce the output segment, in this case a 16-pixel segment Sₖ′. Again, according to the invention, the process may operate in one or several modes, and the decoding process includes a mode parameter module 434 that takes the mode or modes unpacked from the compressed data Cₖ in the unpacking module 432. The inverse smoothing module 450, the inverse quantization module 448 and GR decoding module 442 each perform their part of the decoding process according to the different modes. The result is a decoded and decompressed output segment Sₖ′.

For pixels at high frequency areas, the difference between pixels can be large. This means that the correlation between pixels is small. This leads to a large coding distortion using the conventional methods. According to another embodiment of the invention, in order to reduce the difference between pixels for this case, a novel smoothing filter is used. Let Fₖ={fᵢ, i ε I₁} be the output of the smoothing module. The smoothing process is as follows.
f₀=s₀
f₁=(s₀+s₁)/2
fᵢ=(sᵢ₋₂+sᵢ₋₁+2×sᵢ)/4 for i≧2 (7)
The reconstructed value of sᵢ can be calculated by an inverse smoothing filter as
s′₀=f₀
s′₁=2×f₀−s₀
s′ᵢ=(4×fᵢ−s′ᵢ₋₂−s′ᵢ₋₁)/2 for i≧2 (8)
According to the invention, a packing module that packages the compressed segment would send the compressed segment along with information of any smoothing mode operations so that the segment can be properly decoded when read from memory in response to a read request from a video module.

As discussed above in section above in Section 2.2, the dynamic range of DPCM output yᵢ becomes almost double, comparing to that of the input quantized value xᵢ; More particularly, if xᵢ ε [0, L−1], then yᵢ ε [−(L−1), L−1]. The process requires doubling the indexes for the Rice mapping process. However, when decoding the xᵢ from yᵢ, the value of xᵢ₋₁ is already known. This reduces potential number of xᵢ values. Given xᵢ₋₁, it can be shown that yᵢ ε [−xᵢ₋₁, (L−1)−xᵢ₋₁]. Thus, the dynamic range becomes the same for xᵢ as that of L. This implies that the coding efficiency can be improved by a proper mapping to the index belonging to the range of [0, L−1]. Since, for a typical data value, yᵢ concentrates in a region around the zero, satisfying with the Laplacian distribution, a system configured according to the invention is directed to modify the Rice mapping. Referring to FIG. 6, and according to another embodiment of the invention, a modified Rice mapping process may be implemented. Rather than alternating throughout the entire spectrum, from the value of −7 to the value of +7, the rice mapping process alternates until the end of the location where data actually exists. This is done by keeping the original index counting the same as in Eq. (5) until reaching one end of interval for the possible yᵢ. Then, after one end is reached, the index counting continues from the other side of the spectrum, back to value=−5 in the example of FIG. 6, until the data is processed completely. To illustrate this, an example is given in FIG. 6 for the case of
L=8 and xᵢ₋₁=5.

FIG. 5 shows a normal Rice mapping in which the index counting for zᵢ follows Eq. (5) as zᵢ=0, 1, 2, and 3 for yᵢ=0, −1, 1, and −2, respectively, and so on. FIG. 6 shows the modified Rice mapping. Since xᵢ₋₁=5 and L=8, yᵢ ε [−5, 2]. The counting follows the normal Rice mapping until reaching the value of yᵢ=2. Then, the counting continues as zᵢ=5, 6, and 7 for yᵢ=−3, −4, and −5, respectively. Note that the number of total indexes equals to L=8 as discussed above.

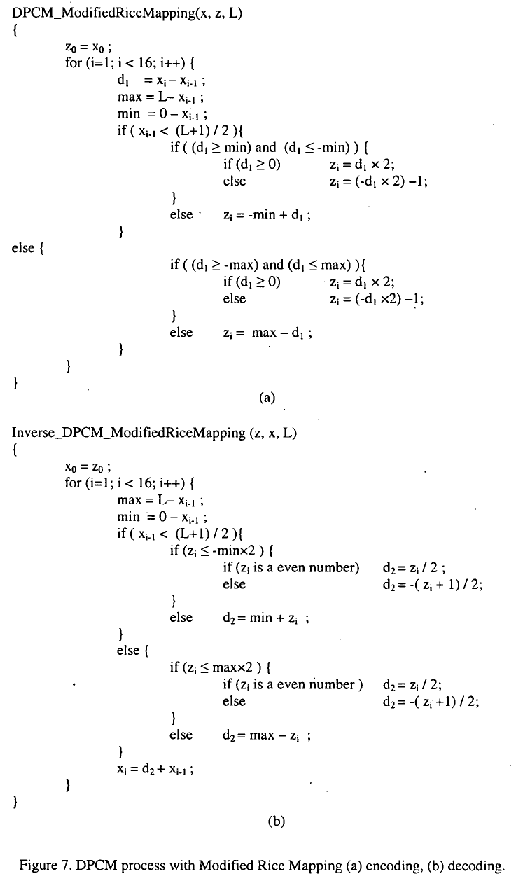

For a better implementation, the DPCM process is combined with the modified Rice mapping. FIGS. 7(a) and 7(b) shows pseudo codes for the encoding and decoding process of this combined processing. Generally, those skilled in the art will mathematically and subjectively understand the function of the pseudo code.

The pseudo code DPCM_ModifiedRiceMapping(x,z,L) of FIG. 7(a) is the encoder operation configured according to the invention, where z₀=x₀. In operation, the process begins just as in the normal and conventional Rice mapping, such as illustrated in FIG. 5 and discussed above. The count alternates on either side of the spectrum, up until an end of the segment is reached. In the first operation, the operation is directed to a video segment the is skewed more toward the positive x quadrant. Here the condition “if ((d₁≧min) and ((d₁≦−min))”, then the operation performs normal rice mapping up until the short end of the segment, a segment in this example, is reached on the negative x quadrant. Then, once the end is reached in the negative x quadrant, the mapping switches to the positive x quadrant to map the remainder of the segment located in the positive x quadrant. Similarly, if the segment is skewed toward the negative quadrant, where the condition is “if ((d₁≧−max) and ((d₁≦max))”, the normal rice mapping is performed until the short end of the segment is reached in the positive x quadrant. After this point, then the modified rice mapping procedure directs the mapping to proceed to the remainder of the segment in the negative x quadrant.

Referring to FIG. 7(b), the inverse operation is illustrated for the decoder end of the operation, Inverse_DPCM_ModifiedRiceMapping(z,x,L), where x₀=z₀. Here, the encoded segments are decoded in the inverse manner, placing the segment data in the location about the z axis, without the need to transmit all of the x values.

Since some segments of a frame are easy to compress while some are not, the coding efficiency can be improved if a portion of bits can be borrowed from other segments that have a surplus of bit space, and use this surplus to encode segments that require more bit space to compress, and are thus difficult to compress. For simplicity, the following borrow bit control when coding the k-th segment Sₖ is represented by
BWₖ=BitsSaveₖ−BitsKeepₖ (9)
BGₖ=BG0+BWₖ (10)
where BitsSaveₖ is the number of saving bits in a pool up to Sₖ from previous segments. Thus, bit space from previous segments are reserved for use in future segments that are difficult to compress and therefore require extra bit space. BitsKeepₖ is the number of keeping bits for the future use so that all of the saving bits are not used up at once. Its value is a function of BitsSaveₖ. This can be implemented in a look-up table. BWₖ is the number of borrowing bits while BGₖ is the bit budget for Sₖ. The BG0 is a normal bit budget for a segment. For 2:1 compression for example, BG0=64 bits. According to equations (9) and (10), the available number of bits for coding Sₖ is increased by borrowing some bits from the bit-saving pool, while the rest of the bits in the pool are kept for some future use. After coding a given Sₖ, BitsSaveᵢ is updated as follows.
BitsSave₍ₖ₊₁₎=BitsKeepₖ+BGₖ−Bitsₖ (11)
where Bitsₖ is the number of bits for coding Sₖ.

To simplify the implementation, it is assumed that the current segment Sₖ will not borrow bits beyond the previous segment Sₖ₋₁ and the compress data of Sₖ putting in the data slot of Sₖ₋₁ in DRAM is attached at the end of that slot. This implies that if BitsSaveₖ is greater than BG0, it is clipped to be BG0.

Furthermore, some bits are needed to indicate the number of borrowing bits for Sₖ so that the decoding process knows how to get the compressed data from the data slot of Sₖ₋₁ In one embodiment, to tradeoff this overhead with the efficiency of borrowing bits, four bits are used to represent the value of BWₖ with a 4-bit resolution so that the full 64-bit range of previous data slot can be identified.

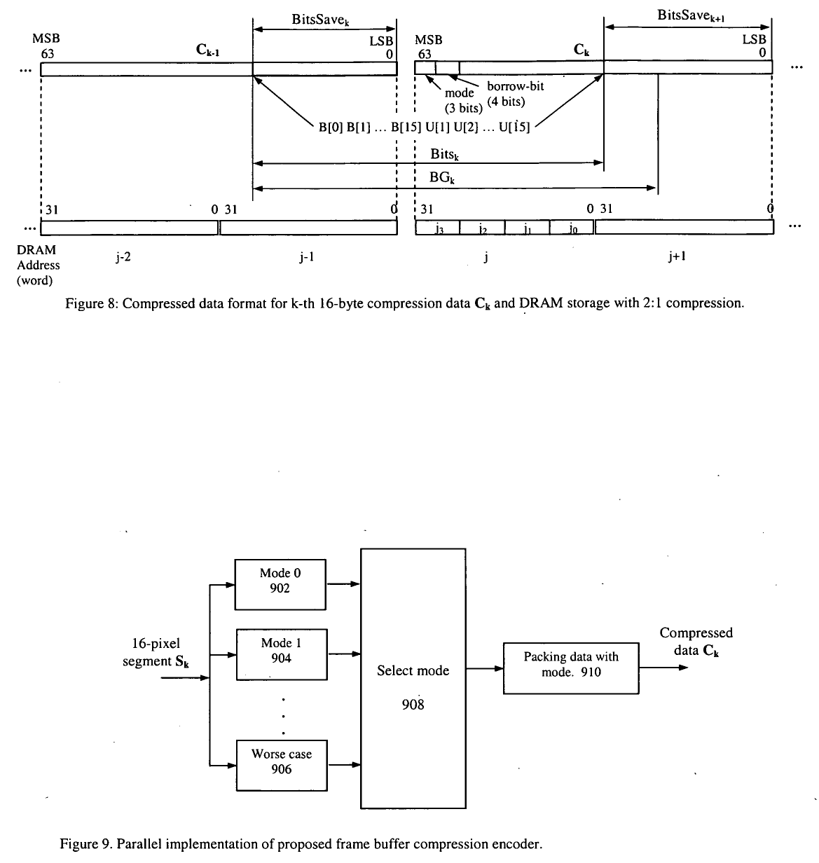

For 2:1 compression ratio, the compressed data format of k-th 16-pixel segment Sₖ is shown in FIG. 8. Each compression slot is 64 bits as Cₖ[63 . . . 0]. The fields of mode and borrow bit are 3 and 4 bits respectively. The mode indicates which mode is used to compress Sₖ. The borrow-bit field is the number of 4-bit units for which the compressed data is in the previous compression data slot Cₖ₋₁[63 . . . 0]. For the worst case mode as mode=7, there is no borrow-bit field.

The B[i] and U[i] are the binary and unary parts of i-th element zᵢ for the GR coding of Zₖ={zᵢ, i ε I₁}, which stored continuously in the shading area of the figure. Note that there is no unary part U[0] for the first element z₀. For the fields of mode, borrow bit, binary and unary parts, the bits are stored in a regular order as MSB first. For example, the mode bits of “100” means that the mode is 4. The B[0]=“000101” means that the value of zero-th data equals 5 for GR coding. The U[1]=“001” means that the unary part of first data for GR coding equals to 2. These compressed data is stored in DRAM as 32-bit words with increasing DRAM address. The Cₖ[63 . . . 32] is stored first as j-th word while the Cₖ[31 . . . 0] is stored in (j+1)-th word.

As discussed above, eight modes are used including the worst case mode to compress the segment. For one implementation, the mode parameters are selected according to Table 1 below. Note that the modes are arranged in an order of using less bits to compress while having more coding distortion, in general.

TABLE 1
Parameter settings for different compress modes,
for 2:1 compression ratio.

| | | | | m of | |
|---|---|---|---|---|---|
| | | | | GR | |
| Mode | Smoothing | Qₛ | DPCM | code | Remarks |
| 0 | no | 1 | Yes | 2 | 1. There is no loss for this |
| | | | | | mode. |
| 1 | no | 2 | Yes | 2 | |
| 2 | no | 4 | Yes | 2 | |
| 3 | no | 8 | Yes | 2 | |
| 4 | yes | 4 | Yes | 4 | |
| 5 | yes | 8 | Yes | 4 | |
| 6 | no | 16 | No | no | |
| 7 | no | 16 or 32 | No | no | 1. It is the worst case mode |
| | | | | | for which the number of |
| | | | | | bits equals to 64 including |
| | | | | | three mode bits. |
| | | | | | 2. Pixels 3, 7 and 11 are |
| | | | | | quantized by 32 and the |
| | | | | | other pixels by 16. |

According to the invention, in the FBC systems, there is a loss for coding input segments except using mode 0. This loss will be accumulated when coding video using schemes with frame predictions. Fortunately, most schemes refresh the frame prediction for a short period, such as having one frame without prediction every 15 frames. This stops the error accumulation and makes the system robust. In the case that the refresh rate is not small, this accumulated error leads to a large coding distortion. This problem becomes more serious for the case that a segment does not change over time because the errors have the same sign. Otherwise, the errors can be cancelled out. According to the invention, in order to reduce the error accumulation problem, it is proposed to change an input segment Sₖ={sᵢ, i ε I₁}, every other frame by subtracting it from the possible maximum value. Thus, for a 8-bit pixel data segment,
sᵢ″=255−sᵢ (12)

This subtraction is equivalent to toggling the bits of sᵢ between zero and one. According to this novel method, by this approach, it can be shown that this accumulation error reduces significantly. For an ideal case, the error can be cancelled out completely. In a preferred embodiment, for the decoding, it requires having the same toggle to recover the segment values. And, for the segment of the same location, toggling bits is performed every other frame. Within a frame, the toggling may be changed for different ways which follows a fixed pattern. The simplest pattern is that all segments of a frame is toggled in the same way.

Referring to FIG. 9, and according to yet another embodiment of the invention, in order to save computation time, the novel system can operate simultaneously in different modes as a parallel system 900 in modules 902, 904, 906 for encoding. In this embodiment, the input segment can be encoded by different modes simultaneously, and the system selects the mode in a predetermined order, such as in selection module 908. The encoded and compressed data can then be packed with the mode data in packing module 910, giving compressed data Cₖ. Some of encoding modules may be shared if the computation is fast enough.

The invention has been described in the context of a system and method for compressing, encoding a video frame in segments for storage in memory, such as a DRAM, and correspondingly decompressing and decoding a video frame in segments according to the modes in which the segments were compressed and encoded. It will be understood by those skilled in the art, however that such systems and methods can be made useful in many other applications, and that the scope of invention or inventions described herein is not limited by the embodiments herein described, but is defined by the appended and future claims and their equivalents.

1. A system for compressing video data, comprising:
a memory device configured to store video data;
a memory controller configured to control the storage of video data in the memory device; and
a frame buffer compression module configured to compress frame data received from a video module to be stored in the memory device according to the memory controller and configured to decompress compressed segments of frame data received from the memory device according to the memory controller for use by a video module.

2. A system according to claim 1, wherein the frame buffer compression module includes
a frame buffer compression encoder configured to encode and compress frame data received from a video module for storage in memory according to the memory controller; and
a frame buffer compression decoder configured to decode and decompress frame data received from memory according to the memory controller for use by a video module.

3. A system according to claim 2 wherein the frame data is compressed in segments.

4. A system according to claim 3, wherein the frame data is compressed in segments and wherein the frame buffer encoder further includes
a quantizer configured to quantize an input frame segment to generate a quantized output;
a DPCM configured to modulate the quantized output to generate a modulated output;
a rice mapping module configured to perform rice mapping on the modulated output to generate a mapped output; and
a variable length coding module (VLC) configured to encode the mapped output.

5. A system according to claim 4, further comprising a bit budget module configured to test whether a compressed segment is within a predetermined limit and feedback loop configured to select mode parameters for the quantizer and the VLC.

6. A system according to claim 4, further comprising a bit budget module configured to test whether a compressed segment is within a predetermined limit, a packing module configured to prepare package including a compressed data segment if the segment is compressed within the predetermined limit and feedback loop configured to select mode parameters for the quantizer and the VLC if the segment is not compressed within the predetermined limit.

7. A system according to claim 6, further comprising a worst case mode module configured to compress the segment if it is not within the predetermined limit wherein the packing unit is configured to prepare and generate a package having the worst case compressed segment and mode information.

8. A system according to claim 4, wherein the frame data is compressed in segments and wherein the frame buffer encoder further includes
a smoothing module configured to perform a smoothing operation on an input pixel segment;
a modified rice mapping component within the rice module configured to perform modified rice mapping on the modulated output to generate a mapped output;
a bit borrowing module configured to share bit space among compressed segments to be transmitted; and
a toggle module configured to perform a toggle operation to change a portion of the input pixel segments by toggling the bits that represent the segments.

9. A system according to claim 4, further comprising a bit budget module configured to test whether a compressed segment is within a predetermined limit, a packing module configured to prepare and generate a packet including the compressed data segment and mode information if the segment is within the predetermined limit, and a feedback loop configured to select mode parameters for the smoothing module, quantizer and the VLC if the packet is not within the predetermined limit.

10. A system according to claim 6, further comprising a worst case mode module configured to compress the segment if it is not within the predetermined limit, wherein the packing unit is configured to prepare and generate a package having the worst case compressed segment and mode information.

11. A system according to claim 3, wherein the frame data is decompressed in segments and wherein the frame buffer decoder further includes
an inverse variable length decoding module configured to decode the mapped output;
an inverse rice mapping module configured to perform inverse rice mapping on the inverse modulated output to generate a mapped output;
an inverse DPCM configured to inverse modulate the inverse quantized output to generate a inverse modulated output; and
an inverse quantizer configured to inverse quantize an input frame segment to generate an inverse quantized output.

12. A system according to claim 11, an unpacking module configured to unpack a received packet packet including the compressed data segment and mode information, and a feed-forward loop configured to send mode parameters for the quantizer and the VLC.

13. A system according to claim 11, wherein the frame buffer decoder further includes
an inverse bit borrowing module configured to share bit space among compressed segments to be transmitted.
an inverse modified rice mapping component within the rice module configured to perform modified rice mapping on the modulated output to generate a mapped output; and
an inverse smoothing module configured to perform a smoothing operation on an input pixel segment.

14. A system according to claim 13, further comprising an unpacking module configured to unpack a received packet including the compressed data segment and mode information, and a feed-forward loop configured to send the compression mode parameters for the smoothing module, quantizer and the VLC.

15. A system according to claim 13, wherein the unpacking module is configured to unpack worst case mode parameters configured to decode any received compressed data that was packed according to a worst case mode.

16. A system according to claim 14, wherein the unpacking module is configured to unpack worst case mode parameters configured to decode any received compressed data that was packed according to a worst case mode.

17. A system according to claim 4, wherein the frame buffer encoder further includes
a bit borrowing module configured to share bit space among compressed segments to be transmitted.

18. A system according to claim 17, wherein the bit borrowing module is configured to maintain a pool of available bit space from previously compressed segments for use to store bits that represent subsequent segments.

19. A system according to claim 17, wherein the bit borrowing module is configured to maintain a pool of available bit space from previously compressed segments up to the bit space required for the previous segment for use to store bits that represent subsequent segments.

20. A system according to claim 4, wherein the rice module configured to perform a modified rice mapping on the modulated output to generate a mapped output that represents the values of a segment that is skewed from a rice mapping center point.

21. A system according to claim 4, wherein the rice module configured to perform a modified rice mapping on the modulated output, where a segment is initially mapped using rice normal rice mapping beginning with a center point until an end of the segment is reached and then maps the remainder of the segment in a consecutive manner to generate a mapped output that represents the values of a segment that is skewed from a rice mapping center point.

22. A system according to claim 4, wherein the frame buffer encoder further includes
a smoothing module configured to perform a smoothing operation on an input pixel segment by averaging the values of a plurality of segments prior to compressing and decoding the plurality of segments.

23. A system according to claim 22, wherein the smoothing process includes transmitting information that a plurality of segments were compressed and encoded according smoothing mode to a decoder so that the segment can be accurately decoded.

24. A system according to claim 4, wherein the frame buffer encoder further includes
a toggle module configured to perform a toggle operation to change a portion of the input pixel segments by toggling the bits that represent the segments.

25. A system according to claim 24, wherein the toggle module is configured toggle the bits of every other frame for the same location.

26. A method for compressing video data, comprising:
receiving write request and video frame data from a video module to store video data into memory;
compressing a frame segment of the data received from the video module; and
storing the compressed segment in a memory device according to a memory controller.

27. A method according to claim 26, further comprising:
receiving a read request from a video module; decompressing compressed segments of frame data received from the memory device according to the read request from the video module;
sending the decompressed segments of frame data to the module.

28. A method according to claim 26, wherein the step of compressing includes encoding and compressing segments of frame data received from a video module with a frame buffer compression encoder for storage in memory according to a frame memory controller.

29. A method according to claim 27, wherein the step of decompressing includes decoding and decompressing segments of frame data received from memory with a frame buffer compression encoder according to a frame memory controller.

30. A method according to claim 28, wherein the step of encoding segments further includes
quantizing an input frame segment to generate a quantized output;
performing differential pulse code modulation (DPCM) of the quantized output to generate a modulated output;
performing rice mapping on the modulated output to generate a mapped output; and
performing variable length coding module (VLC) configured to encode the mapped output.

31. A method according to claim 30, further comprising:
testing with a bit budget module whether a compressed segment is within a predetermined limit; and
selecting mode parameters with a feedback loop for the quantizer and the VLC.

32. A method according to claim 30, further comprising:
testing whether a compressed segment is within a predetermined limit, prepare package including a compressed data segment if the segment is compressed within the predetermined limit; and
selecting mode parameters for the quantizer and the VLC if the segment is not compressed within the predetermined limit.

33. A method according to claim 32, further comprising:
compressing the segment if it is not within the predetermined limit; and
preparing and generating a package having the worst case compressed segment and mode information.

34. A method according to claim 30, wherein the frame data is compressed in segments, the method further including
performing a smoothing operation on an input pixel segment;
performing modified rice mapping on the modulated output to generate a mapped output; and
sharing bit space among compressed segments to be transmitted.

35. A method according to claim 30, further comprising:
testing whether a compressed segment is within a predetermined limit;
preparing and generating a packet including the compressed data segment and mode information if the segment is within the predetermined limit; and
selecting mode parameters for the smoothing module, quantizer and the VLC if the packet is not within the predetermined limit.

36. A method according to claim 32, further comprising:
compressing the segment if it is not within the predetermined limit; and
preparing and generating a package having the worst case compressed segment and mode information.

37. A method according to claim 28, wherein the frame data is decompressed in segments, the method further comprising:
decoding the mapped output with an inverse variable length decoding method; performing an inverse rice mapping on the inverse modulated output to generate a mapped output;
performing an inverse DPCM modulation on the inverse quantized output to generate a inverse modulated output; and
performing an inverse quantization of an input frame segment to generate an inverse quantized output.

38. A method according to claim 37, further comprising unpacking a received packet including the compressed data segment and mode information, and sending mode parameters for the quantizer and the VLC in a feed forward loop.

39. A method according to claim 37, further comprising
sharing bit space among compressed segments to be transmitted using a bit-borrowing operation;
performing a modified rice mapping on the modulated output to generate a mapped output; and
performing a smoothing operation on an input pixel segment.

40. A method according to claim 39, further comprising unpacking a received packet including the compressed data segment and mode information, and sending the compression mode parameters for the smoothing module, quantizer and the VLC in a feed forward loop.

41. A method according to claim 39, wherein the unpacking further includes unpacking worst case mode parameters configured to decode any received compressed data that was packed according to a worst case mode.

42. A method according to claim 40, wherein unpacking includes unpacking worst case mode parameters configured to decode any received compressed data that was packed according to a worst case mode.

43. A method according to claim 30, further comprising sharing bit space among compressed segments to be transmitted.

44. A method according to claim 43, wherein sharing the bit space includes maintaining pool of available bit space from previously compressed segments for use to store bits that represent subsequent segments.

45. A method according to claim 43, wherein sharing the bit space further includes maintaining a pool of available bit space from previously compressed segments up to the bit space required for the previous segment for use to store bits that represent subsequent segments.

46. A method according to claim 30, wherein the rice mapping further includes performing a modified rice mapping on the modulated output to generate a mapped output that represents the values of a segment that is skewed from a rice mapping center point.

47. A method according to claim 30, wherein the rice mapping includes performing a modified rice mapping on the modulated output, where a segment is initially mapped using rice normal rice mapping beginning with a center point until an end of the segment is reached and then maps the remainder of the segment in a consecutive manner to generate a mapped output that represents the values of a segment that is skewed from a rice mapping center point.

48. A method according to claim 30, further comprising:
performing a smoothing operation on an input pixel segment by averaging the values of a plurality of segments prior to compressing and decoding the plurality of segments.

49. A method according to claim 48, wherein the smoothing process includes transmitting information that a plurality of segments were compressed and encoded according smoothing mode to a decoder so that the segment can be accurately decoded.

50. A system according to claim 30, wherein the frame buffer encoder further includes
a toggle module configured to perform a toggle operation to change a portion of the input pixel segments by toggling the bits that represent the segments.

51. A system according to claim 50, wherein the toggle module is configured toggle the bits of every other frame for the same location.
